(19) United States
(12) Patent Application Publication
(10) Pub. No.: US 2014/0114754 A1
(43) Pub. Date: Apr. 24, 2014

(54) DATA ACCUMULATION SYSTEM

(71) Applicant: Makoto Oshima, Hyogo (JP)

(72) Inventor: Makoto Oshima, Hyogo (JP)

(21) Appl. No.: 14/124,420

(22) PCT Filed: Jun. 14, 2012
(86) PCT No.: PCT/JP2012/065204

§ 371 Date: Dec. 6, 2013

(30) Foreign Application Priority Data
Jun. 23, 2011 (JP) 2011-139968
Aug. 2, 2011 (JP) 2011-169678
Oct. 26, 2011 (JP) 2011-235488

(51) Int. Cl. G06Q 30/06

(52) U.S. Cl. CPC G06Q 30/0643
USPC 705/14.49; 705/27.2

(57) ABSTRACT

New business that uses the Internet and that is provided by a photography business operator, such as the creation of an electronic album, is being developed. However, in business via the Internet, a relationship between the photography business operator and its customer tends to be temporary and it is hard to build a long-term relationship with the customer. Hence, a storage system on the network, which stores data such as photographs, is configured such that the customer being a system user can seek communication with a third party via a photograph. Thus, with the use of the system, it becomes possible to build a long-term business relationship.

### TECHNICAL FIELD

The present invention relates to a product-fitting system, an image processing system for processing an image posted on a social network, and a photo communication system using these systems.

### BACKGROUND ART

When purchasing products such as clothes, hats, and gloves, for example, a user (consumer) generally tries on products he/she likes in a store in advance, followed by determining a product that suits him/her from among a plurality of products. However, there is a problem in the user repeating trying on products until he/she becomes satisfied that it requires much effort and takes a long time.

Conventionally, there is a fitting experience system using a website for solving such a problem. The fitting experience system superimposes an image such as clothes on a mannequin image or model image that reflects the user's body dimensions, and represents it on a display. The fitting experience system allows the user to repeat the fitting until he/she becomes satisfied without a fitting in a store. The user can then find and purchase products that he/she likes.

However, in the conventional fitting experience system, the mannequin image or model image is an image that reflects the body of a representative user thereon or an image based on, the predetermined parameters (for example, height and weight) of a user. Hence, the mannequin image or model image does not perfectly reflect the characteristics of the body of the user. It is hard for a user who used the conventional fitting experience system to feel the reality that he/she actually tried on a product. Moreover, there is a problem that it is hard for the user to determine whether the product he/she tried on really suits him/her.

As a technique for solving such a problem, JP-A-2004-86662 (Patent Document 1) discloses a method for providing a clothes-fitting service that provides a service to try on clothes by compositing images on a screen. In the method for providing the clothes-fitting service, a management server that manages data necessary to try on clothes establishes connection with a user terminal device operated by a user via a network. In addition, clothes-drawing data for drawing the clothes on the screen is stored in clothes-drawing data storage means connected to the management server. Next, the management server uses an image of the user taken by photographing means to set representative body points that represent the user's body shape. By request of the user from the user terminal device, clothes-drawing data transmission means of the management server transmits the clothes-drawing data stored in the clothes-drawing data storage means to the user terminal device via the network. The user terminal device has data-processing means for clothes drawing. The data-processing means processes the clothes-drawing data based on the data of representative body points. Then, the data-processing means deforms the clothes into a state of fitting the user's body shape. Image composition means of the user terminal device subsequently uses the processed clothes-drawing data to superimpose the clothes on the image of the user and display it on the display means.

Even if the user has any kind of shape, build, or figure, the management server allows the user to try on clothes prepared thereon. Thus, the user can easily check whether the clothes suit him/her on a screen of the display means of the user terminal device.

Moreover, JP-A-2007-11543 (Patent Document 2) discloses a product wearing simulation system where a user simulates the wearing of a product. The system includes a user's terminal device and a server connecting thereto via a network. The server includes storage means. The storage means stores body image information that shows the appearance of the body of the user and product image information that shows the appearance of a product. The storage means stores positional information for a deformation point. The positional information indicates each of the positions of a plurality of deformation points arranged on the product image information to fit a body shape of the body image information and deform a product shape of the product image information. Moreover, the terminal device includes means for acquisition of an image or the like, means for displaying a body image, and means for moving a deformation point. The means for acquisition of an image or the like acquires from the server the body image information, the product image information, and the positional information for a deformation point, which are stored in the server. The means for displaying a body image displays the acquired body image information. The means for moving a deformation point changes the acquired positional information for a deformation point to move the position of the deformation point. Furthermore, the terminal device includes means for deforming a product image and means for displaying a deformed product. The means for deforming a product image deforms a product shape of the acquired product image information based on the changed positional information for a deformation point. The means for displaying a deformed product displays the product image information on the deformed product shape on the displayed body image information.

Hence, if a photograph image that captured the user himself/herself or the like is used as the body image information, the product image information of the product shape that fits the user's body shape or the like is used to enable the wearing simulation.

Thus, the simulation result that looks closely like the user who actually wears the product can be obtained.

Moreover, in recent years, communication between friends is coming to be made by using a social network.

Some of social network users (hereinafter simply referred to as users) wish their friends to comment on, for example, their make-up, hairstyle, or clothing from their friends.

Moreover, other users wish to communicate with their friends by modifying images of their friends posted on the network.

However, under present circumstances, there is not a method and means for processing an image posted on a social network.

Patent Document 1 proposes a technique for creating an electronic album where an image matches music by use of a network system.

Furthermore, new business where what is called a photography business operator provides a service to create an electronic album has also been developed by using the Internet. However, a relationship between the photography business operator and its customer tends to be temporary in business via the Internet. A further scheme is needed to build a long-term relationship between the photography business operator and the customer.

### CITATION LIST

### Patent Literatures

Patent Document 1: JP-A-2004-86662
Patent Document 2: JP-A-2007-11543
Patent Document 3: JP-A-2003-116094

### DISCLOSURE OF THE INVENTION

### Problems to be Solved by the Invention

However, in the photography business via the Internet, an anniversary of a customer is found from, for example, the personal information of the customer to build a long-term relationship with the customer. For example, considered is such a measure as to encourage sales promotion by sending an advertisement for a commemorative photograph to the customer by email or the like before the anniversary. However, considering the recent situation where persons are careful about the disclosure of their personal information, it is not easy to obtain the personal information of customers.

### Solutions to the Problems

In the present invention, a data storage system for storing data such as a photograph includes: storage means for allowing computers belonging to a plurality of customers to communicate with one another, and allowing a manager and the plurality of customers to upload data such as a photograph; customer-authentication management means for authenticating the customer who logs in to the system and managing authentication information; access-right setting means for setting, on instruction of the manager, which customer is permitted to view the data such as a photograph uploaded by the manager to the storage means and which customer is permitted to edit the data such as a photograph, among the plurality of customers, and saving the settings; customer-information management means for storing customer information that the customer is permitted to upload to the storage means; date-and-time specification transmission means for performing a setting to transmit a fact that information on the data such as a photograph stored in the storage means and specified by the customer, an access right of the data being held by the customer, is viewable by the data storage system, to a specified person on a specified date; and fitting means for enabling the manager to upload fitting data of clothes or the like to the storage means and enabling the customer to try the fitting data of clothes or the like on a photograph or moving image that is editable by the customer himself/herself, view the photograph or moving image on which the fitting has been performed, and upload the photograph or moving image to the storage means. The manager of the data storage system is a photography-related business operator or a person who is commissioned by the photography-related business operator, and the access-right setting means sets, on instruction of the customer, whether the manager is permitted to view each of data such as a photograph uploaded by the customer to the storage means or which customer among the plurality of customers is permitted to view each of the data, and whether the manager is permitted to edit each of the data or which customer among the plurality of customers is permitted to edit each of the data, and saving the settings.

The data storage system includes correction request means for particularly enabling the customer to request the manager to make a desired image correction on the photograph on which the fitting has been performed.

Moreover, the data storage system includes advertisement transmission means for particularly enabling transmission of an advertisement for the manager to the customer.

Furthermore, the advertisement transmission means particularly edits a photograph of a customer, which is editable by the manager, and transmits the photograph together with the advertisement to the customer.

In addition, particularly upon the specified person being the customer of the data storage system, the date-and-time specification transmission means determines means for transmission to the specified person using the customer information stored in the customer-information management means.

Moreover, the date-and-time specification transmission means particularly transmits to the specified person the fact that the information on the data specified by the customer is viewable by the data storage system, and information to log in to the data storage system.

In addition, the data storage system particularly includes database means usable by the customer.

Moreover, the data storage system particularly includes album creation means for enabling creation of an album using a plurality of photographs viewable or correctable by the customer.

In addition, particularly, the manager or a manufacturer of the clothes and the like edits a photograph of a customer, the photograph being editable by the manager, and the advertisement transmission means transmits to the customer the photograph together with an advertisement of the manufacturer of the clothes and the like.

Moreover, the fitting means particularly cooperates with a website of a manufacturer of clothes and the like to allow the customer to access images of clothes and the like provided by the manufacture of clothes and the like and enable placing of an order for clothes and the like selected by the customer to the manufacturer of clothes and the like.

### Effects of the Invention

The system of the present invention is configured as described above. The system, which is operated and managed by a photography-related business operator or the like, is used to automatically transmit information on a photograph and a voice message. The photograph and the voice message respectively become a memory and commemoration on an anniversary and the like of a family or friend, representing turning points in life. Thus, a person's feelings can be conveyed to his/her family or friend. Thus, it becomes possible to occasionally make an impression, occasionally give a surprise, or give enjoyment. In this manner, the system functions as a communication tool that uses photographs, which are those bringing a person special emotions throughout his/her lifetime. Hence, the system promotes the customer's long-term use. Thus, the relationship between the photography-related business operator and the like and the customer that essentially tends to be temporary can be prolonged.

### BRIEF DESCRIPTION OF THE DRAWINGS

FIG. 1 is a diagram illustrating a system configuration of a data storage system according to the present invention.

FIG. 2 is a block diagram illustrating a system configuration of the data storage system according to the present invention.

FIG. 3 is a flowchart for specified date-and-time setting means of the data storage system according to the present invention.

FIG. 4 is a flowchart for transmission means of the data storage system according to the present invention.

FIG. 5 is a diagram illustrating a first example of the use of the data storage system according to the present invention.

FIG. 6 is an exemplary diagram illustrating the display of a photograph of the data storage system according to the present invention.

FIG. 7 is a diagram illustrating a second example of the use of the data storage system according to the present invention.

FIG. 8 is a diagram illustrating a third example of the use of the data storage system according to the present invention.

FIG. 9 is a diagram illustrating a fourth example of the use of the data storage system according to the present invention.

FIG. 10 is a diagram illustrating a fifth example of the use of the data storage system according to the present invention.

### DESCRIPTION OF EMBODIMENTS

### Embodiment

Hereinafter, an embodiment of a data storage system will be described. An idea of a system that performs image processing and the like to enjoy communication with friends, the communication using a product-fitting system and a social network, is applied to the data storage system. The data storage system is a system managed mainly by a photography-related business operator. It is assumed that customers of the manager are users who use the system. The photography-related business operators include a manufacturer of photography-related products such as cameras or photograph printing paper, and a retailer of these products in addition to a photography business operator who takes a commemorative photograph and the like by request of a customer, or develops and prints a photograph. In other words, the photography-related business operators include all business operators for what is called the photography-related industry.

The following embodiment is an example where the present invention is embodied, and the present invention is not limited by this.

### <System Configuration>

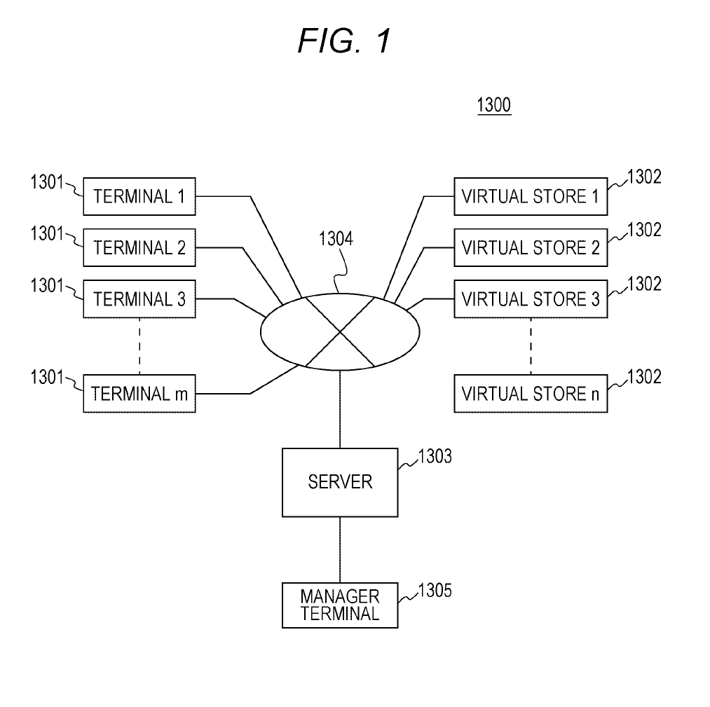

Firstly, the configuration of a data storage system 1300 according to the embodiment will be described with reference to FIG. 1. As illustrated in FIG. 1 the data storage system 1300 has a configuration where a plurality of terminal devices 1301 is connected to a server computer 1303 via a network 1304 such as the Internet. A virtual store 1302 of a clothing manufacturer or the like, or a manager terminal 1305 is provided as needed.

The terminal device 1301 may be a mobile terminal device or a general notebook or desktop computer. The terminal device 1301 includes input means such as a keyboard, mouse, or touchscreen. It is sufficient if the terminal device 1301 is one including display means for displaying information or an image, memory necessary to hold information displayed and perform an operation and the like, and a transmission/receiving function to mutually exchange data with the server computer 1303 via the network 1304.

A general desktop computer is suitable for the server computer 1303. It is desirable that the server computer 1303 include especially large capacity memory, such as HDD (HARD DISK DRIVE), that can store a large amount of data. The server computer 1303 can transmit and receive data via the network 1304 similarly to the terminal device 1301.

The network 1304 is a two-way network, such as the Internet, that can exchange data with each other. Also in the invention according to the embodiment, it is desirable that the network 1304 can perform high-speed data communication to exchange image data.

The virtual store 1302 is provided as needed. An order can be placed in the virtual store 1302 by clicking a displayed product image, as in a known virtual store. In the invention according to the embodiment, the virtual stores are assumed to be mainly an apparel store and the like.

The manager terminal 1305 is also provided as needed. For example, if a place where the server manager is away from a place where the server computer 1303 is placed, the server manager uses the manager terminal 1305 to enable the control of the server computer 1303. As described above, a photography-related business operator or a management company under commission from the photography-related business 1I operator is suitable as the server manager of the system.

### <Detailed Configuration and Operation of System>

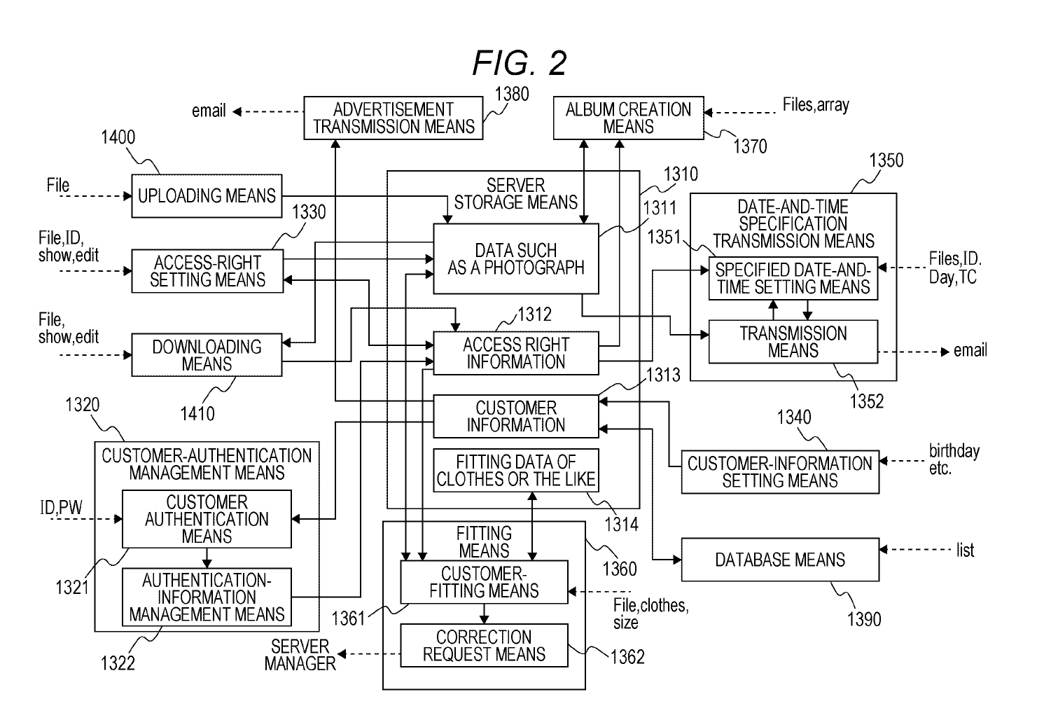

A specific configuration and operation of the system will be described with reference to FIG. 2. FIG. 2 is a block diagram illustrating the system configuration. The system includes server storage means 1310, customer-authentication management means 1320, access-right setting means 1330, customer-information setting means 1340, date-and-time specification transmission means 1350, fitting means 1360, album creation means 1370, advertisement transmission means 1380, database means 1390, uploading means 1400, and downloading means 1410.

The server storage means 1310 is large capacity memory, for example, HDD provided in the server computer 1303. For convenience of management, the memory of the manager terminal 1305 may be used as part of the server storage means 1310. The server storage means 1310 can also use a large capacity removable medium such as DVD (DIGITAL VERSATILE DISC) or blu-ray disc accessorily. A data group such as data such as a photograph 1311, access right information 1312, customer information 1313, and fitting data of clothes or the like 1314 is saved in the server storage means 1310.

The data such as a photograph 1311 may include only data of photographs or image and video data other than audio and photographs. The image data of photographs and the like may be saved in a JPEG (JOINT PHOTOGRAPHIC EXPERTS GROUP) or GIF (GRAPHICS INTERCHANGE FORMAT) format to compress the data capacity. Alternatively, if the server storage means 1310 has a sufficiently large storage capacity, the image data of photographs and the like may be saved without being compressed. Alternatively, it may be configured such that a person who uploads can select a save format. The audio data shall be dealt with in the same manner, and may be saved in a compression format such as MP3 (MPEG AUDIO LAYER-3). The data may be uploaded by a customer from his/her own terminal 1301. Alternatively, the server manager may save the data using the server computer 1303 and upload the data by the manager terminal 1305. A file name is individually attached to the uploaded data such as a photograph 1311. The data such as a photograph 1311 is saved distinguishably from another file.

The access right information 1312 is information that stipulates an access right to each file of the data such as a photograph 1311. The access right information 1312 stipulates, for each file, a person who can set an access right, a person who can view, and a person who has authorization to perform up to edition (correction, and change of a file name). The person who can set an access right is a person who uploaded a file in principle. Hence, when a file is uploaded, a user ID of a person who uploaded the file is written in the access right information 1312 as a person who can set an access right to the file concurrently with the writing of the data such as a photograph 1311 in the file.

The customer information 1313 is data on a customer being a user of the system. The customer information 1313 contains information input by the customer at the start of using the system, and also information subsequently corrected or added. The customer information 1313 is information such as user ID, login password, email address, name, age, address, payment method, credit card information, family structure, and birthday. These pieces of information include information that is required to be input and information that the customer can input arbitrarily. For example, the information on user ID, login password, email address, name, age, address, and payment method is information that is required to be input and the other information is information that is input arbitrarily.

The fitting data of clothes or the like 1314 is images such as clothes and accessories. The fitting data of clothes or the like 1314 is data used when performing virtual fitting using a photograph. The fitting data of clothes or the like 1314 is uploaded by the server manager. Moreover, a manager of the virtual store 1302 may obtain permission from the server manager and upload the fitting data of clothes or the like 1314.

The customer-authentication management means 1320 includes customer authentication means 1321 and authentication-information management means 1322. Upon a login to the system, the user inputs authentication information. There are some possible methods as the authentication method. It is assumed here that the user uses his/her own terminal 1301 to input his/her user ID and password from a keyboard or the like and transmit the data to the server computer 1303. When receiving the user ID and password from the user, the customer authentication means 1321 verifies whether the user ID and password are correct login information by referring to the customer information 1313. If the received user ID and password agrees with the user ID and password saved in the customer information 1313, the customer authentication means 1321 recognizes that the user is a customer who has already been registered for the use of the system. The customer authentication means 1321 then transmits the user ID to the authentication-information management means 1322.

The authentication-information management means 1322 checks address information of the user terminal 1301 on the network. The authentication-information management means 1322 then associates the address information on the network with the user ID and writes them in the access right information 1312. When the user logs out, the authentication-information management means 1322 deletes from the access right information 1312 the address information of the user's terminal 1301 and the user ID, which have been written on the network.

The access-right setting means 1330 performs the above-described setting of the access right information. The person who can set an access right is in principle a person who uploaded a file where an access right is set. If the setting of an access right is not performed at all concurrently with the uploading, only the person who uploaded the file can view and edit the file. An access right can be set at the time of uploading a file and also after the uploading. Alternatively, an access right can also be changed. In the setting of an access right, a fine name that is desired to be set, a user name (or user ID) that receives the access right, and the kind of access right (whether only viewing is possible or edition is also possible) are specified. The access-right setting means 1330 accepts these specifications.

The access-right setting means 1330 then consults the access right information 1312 first, and thus verifies whether the user who is performing the setting is a user who has access-right setting authorization in the following procedure. Firstly, the access-right setting means 1330 reads the user ID of the user's terminal 1301 from the access right information 1312. The user ID corresponds to the address information on the network. Furthermore, the access-right setting means 1330 reads from the access right information 1312 for which file the person corresponding to the user ID has the access-right setting authorization. As a consequence, when determining that the user definitely has the access-right setting authorization for the file where the access right is to be set, the access-right setting means 1330 records the content of the specification in the access right information 1312.

The customer-information setting means 1340 writes information on the user, which has been transmitted from the user, in the customer information 1313. When the user uses the system, the customer-information setting means 1340 checks whether all of required information is input upon use registration. If there is an entry that has not been input, the customer-information setting means 1340 transmits to the user an alarm that prompts an entry, or the like. Information can be corrected and added whenever the user desires.

The date-and-time specification transmission means 1350 includes specified date-and-time setting means 1351 and transmission means 1352. The date-and-time specification transmission means 1350 executes a function to automatically transmit information on the file where the access right that the user can view is set among files stored in the data such as a photograph 1311, or the fact that the information is viewable to a specified email address on a specified date and time.

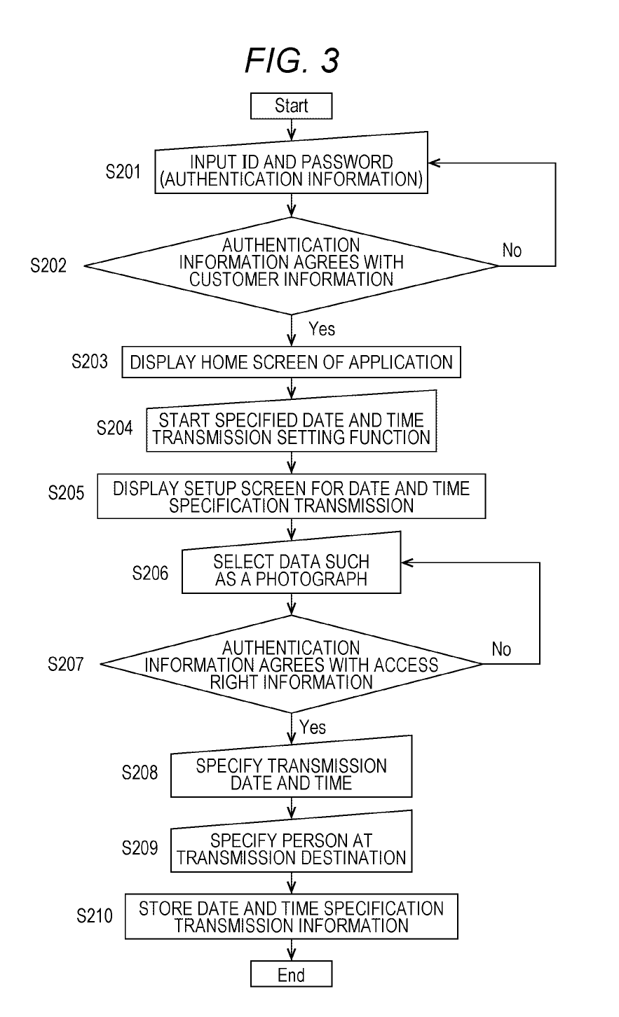

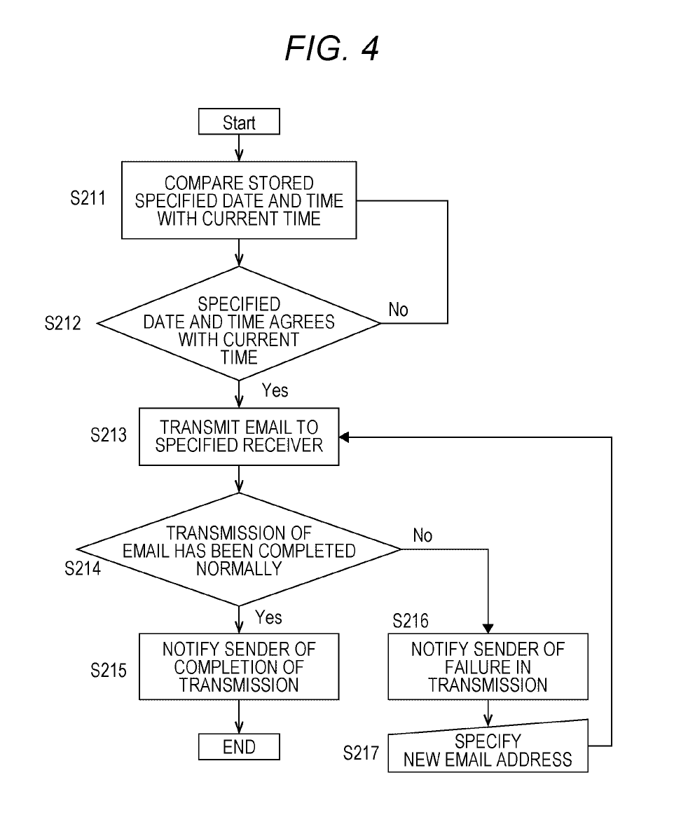

The specific operation will be described with reference to FIGS. 3 and 4.

Firstly, in FIG. 3, when authentication is performed in S201 and S202 and a login is performed, a home screen of the system is displayed (S203). If the “setting of the transmission of date and time specification” is selected on the home screen, the specified date-and-time setting means 1351 is started (S204). A setup screen for date and time specification transmission is then displayed (S205). The user then selects a photograph or audio that he/she desires to transmit (S206). The specified date-and-time setting means 1351 consults the access right information to verify whether the user performing the setting is a user who has the access right authorization that permits viewing (S207). The specified date-and-time setting means 1351 reads from the access right information 1312 the user ID of the user's terminal 1301 corresponding to the address information on the network. Furthermore, the specified date-and-time setting means 1351 reads information on to which file the person corresponding to the user ID has the access right. If determining that the user who has the access right that permits viewing is performing specification for the selected file, the specified date-and-time setting means 1351 specifies a transmission date and time (S208) and specifies an email address of a person at a transmission destination (S209). If the person at the transmission destination is the user of the system, the specified date-and-time setting means 1351 may simply specify a user name, and transmit to the email address of the person at the transmission destination, the email address being registered in the customer information 1313. The specified date-and-time setting means 1351 writes these pieces of information in memory that can be accessed by the transmission means 1352. On the other hand, if determining that the user who has the access right that permits viewing is not making specifications, the specified date-and-time setting means 1351 returns again to the screen to select a photograph and audio that are desired to be transmitted (S206).

One file has been selected here, but a plurality of files may be set to be selectable. Alternatively, also in terms of the person at the transmission destination email addresses of a plurality of persons may be selected.

Next, the operation of the transmission means 1352 will be described with reference to FIG. 4.

The transmission means 1352 compares the specified transmission date and time with a current date and time (S211 and S212). If the condition is satisfied, the transmission means 1352 transmits an email to the specified email address (S213). If the person at the transmission destination is the user of the system, the transmission means 1352 may transmit an email to an email address that is most newly updated and registered in the customer information 1313. The name of a person who specified the transmission is described here in the email. Alternatively, if the person who specified the transmission desires, a message is described in the email. A message to the effect that a photograph or voice message specified using the system can be viewed is described in the email. Moreover, in the email, the URL of the system, and the user ID and password are described, and a message to the effect that the specified file can be viewed by a login is described. If the file is a photograph, its thumbnail may be attached to the file or the photograph itself may be attached.

The transmission means 1352 checks whether the transmitted email has been transmitted normally (S214). When checking that the transmission has been performed normally, the transmission means 1352 notifies the person who specified the transmission of the fact that the transmission has been completed normally in a specified contact method such as an email (S215). On the other hand, if the transmission of the email has not been performed normally, the transmission means 1352 notifies the person who specified the transmission of the fact that the transmission has not been performed normally (S216). The transmission means 1352 then takes such a measure as to transmit the email to another email address specified by the person who specified the transmission (S217).

It is also effective to add a time capsule function as a special function to the date-and-time specification transmission means 1350. For example, the date-and-time specification transmission means 1350 creates a folder corresponding to a time capsule in the data such as a photograph 1311 when the specified date-and-time setting means 1351 transmits a specified transmission date and time, user names that can join the time capsule function, and writing expiration in addition to a flag that specifies the time capsule function. If a time capsule is created upon graduation, graduates and teachers are appropriate as users who can join. In order to provide an access right to write data in the folder to users who can join the time capsule function, access right information on the folder is recorded in the access right information 1312. The access right is effective until the specified writing expiration. After the expiration, writing is prohibited. The above operation enables a plurality of users to write photographs and audio data, which they have the access authorization to view, in the folder. The users write in the folder data of photographs and voice messages that they individually desire to see in the future. As if everybody puts their mementos in a real time capsule, the folder full of memories is completed. When the specified transmission date and time comes, an email where a message that the folder has become viewable is described is transmitted to the users who can join. Since this is the time capsule, it is desirable that a time when its content can be viewed be limited to the above-described writing expiration date or the like. For example, in terms of viewing the data in the folder, it may be set such that the data of all the persons can be viewed until the writing expiration, and thereafter only a person's own data uploaded to the folder can be viewed. Alternatively, it may be set such that data uploaded by others to the folder cannot be viewed from the beginning.

The fitting means 1360 includes customer-fitting means 1361 and correction request means 1362. The customer-fitting means 1361 has a function to try clothes, accessories, and the like, which have been selected from the fitting data of clothes or the like 1314, on a photograph that the customer can edit. The customer-fitting means 1361 determines first whether the customer has access authorization that permits edition for the photograph to be used for fitting. The determination of the presence or absence of the access authorization is a similar operation to the above-described determination by the specified date-and-time setting means 1351, and therefore the description will be omitted. If the photograph to be used for fitting is determined to be a photograph for which the customer has the access authorization that permits edition, the customer can select clothes, accessories, and the like, which he/she desires to try on, from the fitting data of clothes or the like 1314, and try them on the photograph. The fitting data of clothes or the like 1314 is categorized to match various events. Thus, the user can find his/her desired clothes and the like efficiently. For example, Japanese clothes and hair accessories for children can be selected from a category of the “Shichi-Go-San Festival (in Japan)” for children of three five, and seven years of age. Moreover, a category of graduation ceremony is further fragmented, and includes subcategories of graduation from kindergarten to graduation from university. Clothes and the like that are appropriate to their respective categories can be selected. The photograph that has completed the fitting can be uploaded to and saved in the data such as a photograph, or saved on his/her own computer.

Moreover, the fitting data of clothes or the like 1314 may contain photographs of clothes and the like, which are provided by the virtual store 1302 that has obtained permission from the server manager. In this case, an order placement function may be added to the fitting data of clothes or the like 1314.

If the above photograph that has completed the fitting is desired to be made more beautiful, a request to the server manager for correction can be made by the correction request means 1362. The server manager corrects the photograph that has completed the fitting in accordance with a desire of the user. The server manager makes a correction so as to make the clothes and the like to fit the body shape of the subject, sets the user's desired background suitable for an event, or corrects the subject's facial expression. The corrected photograph is provided as an electronic file or printed photograph in accordance with a desire of the user. Alternatively, if there is a plurality of corrected photographs, the photographs are provided as a bound album.

The album creation means 1370 is used to enable the user to create an album. For example, a plurality of photographs that the user has access authorization to view is selected, and the layout is transmitted. Thus, an electronic album is easily created. The layout may be arranged freely, or some layout examples prepared by the system may be used. Moreover, the title and cover of the album can also be selected. Moreover, a text message or voice message can also be added. The created album can be saved as an electronic file in the data such as a photograph 1311. Alternatively, the electronic file may be saved on his/her own computer or the like. Moreover, the electronic file can also be automatically transmitted by the date-and-time specification transmission means 1350 on a specified date and time.

The server manager can transmit a timely advertisement to the user by the advertisement transmission means 1380 by referring to the customer information 1313. For example, if it is determined from information on the birthday of the user that her coming-of-age ceremony is approaching, the advertisement transmission means 1380 can transmit an advertisement encouraging the taking of a commemorative photo of the coming-of-age ceremony on the system or by email or the like. Furthermore, if there is a photograph that the server manager has the access right that permits edition among photographs of the user, the advertisement transmission means 1380 can attach a fitting photograph that has tried on a long-sleeved kimono for the coming-of-age ceremony to the advertisement by email.

Upon user registration and the like, permission for the transmission of an advertisement shall be obtained from the user. Advertisements shall be transmitted only to users who permit the transmission of advertisements. Moreover, also in terms of customer information, permission to use the customer information upon the transmission of an advertisement shall be checked in advance.

Moreover, the customer information is compiled into a database. The customer information that the user can use is configured such that the user can search by the database means 1390. For example, considered is a case where a yearbook is created using the system upon graduation from junior high school. Persons who can view are graduates and teachers. Moreover, it may be configured such that the families of the students can also view. Information on persons who can view is input in the customer information of the system. A yearbook is created every year using the system. Thus, the database of the graduates of the school is created. The graduates and teachers use the system and thus can correct their contact information such as address when changing residence. The database means 1390 performs various searches and extractions to help the transmission of notifications of an alumni reunion and various events.

The uploading means 1400 is used by the user or server manager to upload photographs and audio files. A file name is assigned to data to be uploaded, and the data is saved in the data such as a photograph 1311. As described above, the access-right setting authorization for the file is written in the access right information 1311.

The downloading means 1410 enables the data stored in the data such as a photograph 1311 to be downloaded to the user's terminal 1301 on a file by file basis. Upon downloading, the access right is checked as described above. If a user who requested download has edition authorization, download is possible in an editable file format. On the other hand, if a file that the user does not have access authorization is selected, a message to that effect is transmitted to the user.

### <Example of Use of the System>

Next, an example of the use of the system will be described.

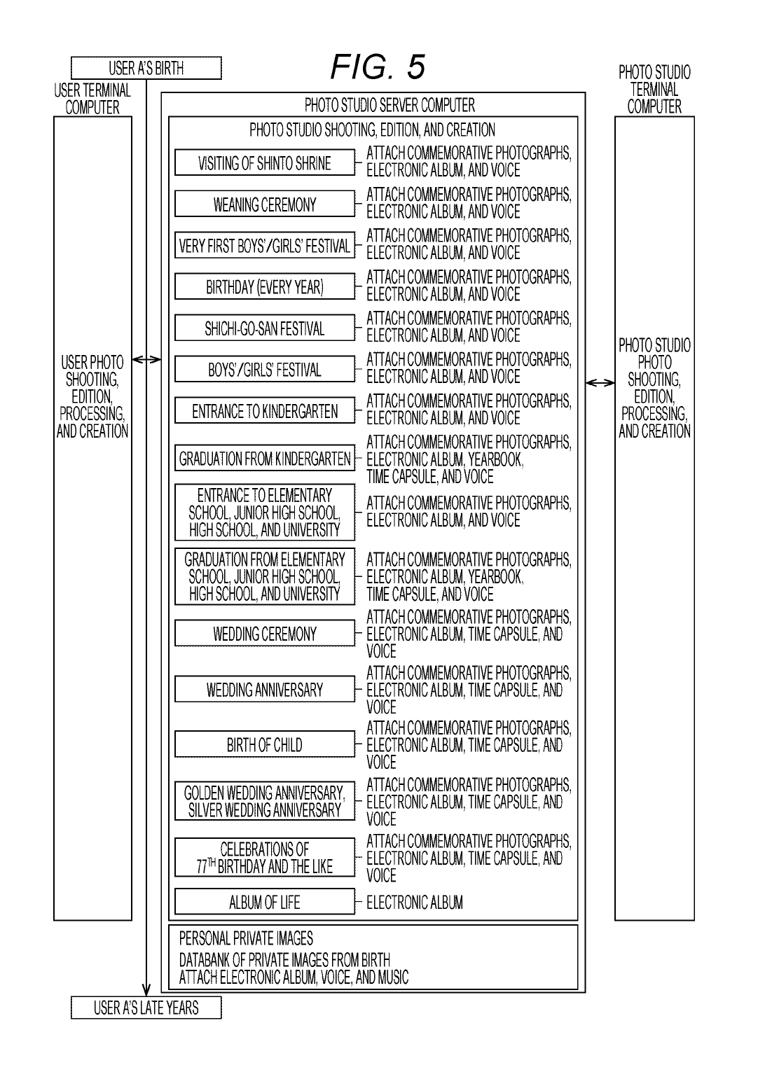

FIG. 5 illustrates event being turning points in life, which may use the system, in the center in various stages from a person's birth to late years, the system is used. Moreover, the system has various uses. For example, upon entrance into kindergarten, the photo shooting of a child in a school uniform of the kindergarten is photographed in a studio of a photography-related business operator being the server manager of the system and an electronic album is uploaded to the system. Thus it becomes possible by the system to let his grandmother and grandfather living far away see the child grow. Moreover, the voice of the child is uploaded as an audio file to let the grandparents listen to the voice of the child. A message from the child can be sent to grandpa and grandma who live far away.

Moreover: feelings from the parents to the child can also be made into a voice message. Automatic transmission on the child's coming-of-age ceremony is set by the date-and-time specification transmission means 1350 and thus feelings and affections from the parents to the child at the time of entrance into kindergarten can be conveyed when he/she grows up.

Furthermore, in terms of photo shooting, it is also possible to make a selection that the parents take photographs not in a studio but by themselves, and an upload to the system is carried out to create an electronic album. The photography-related business operator is only requested to print and bind the electronic album, which enables a reduction in the cost of creating the album.

Moreover, at the time of graduation from school, not only an official album, but volunteers of the class gather together to create a time capsule. However, the time capsule may be lost due to the future transfer or closure of the school, or because the time capsule is dug tip due to construction or the like. Moreover, the capsule's existence itself may be forgotten after a long period of time. In order to prevent them, in other words, to prevent the loss and oblivion of important memories, a time capsule of an electronic file is created with the system. A future date and time to open the time capsule is decided and the system is started when the specified date and time comes at some future date, and thus the electronic file can be viewed. The time capsule can contain not only photographs but also a future dream as an audio file and a composition as a text file.

In this manner, the system keeps all images of life such as the server storage of a collection of messages at the time of graduation from school, a yearbook, digitized use of a time capsule, voice messages of an image album of a circle or friends, a wedding memory album, commemorative photographs upon the birth of a child, and personal images. An album including images of a person's late years with his/her family and grandchild is created and a voice message is attached thereto. The album is left to the family, or the image of his/her life is used for the decoration of the funeral. Thus, a person can express his/her gratitude to persons who helped him/her while alive. Moreover, if a person feels embarrassed to express his/her feelings to his/her mentor or friend face to face, an image album (on which the date and time specification setting has been performed) with a voice message attached is passed in advance to the mentor or friend. At some future date, when the specified date and time comes, the system is started and thus a message of feelings to the mentor or friend, or the words of gratitude can be conveyed.

Furthermore, an album is created with images of a wedding ceremony and current feelings are left as a voice message. The voice message is listened again in the future, or a commemorative photograph is taken on every wedding anniversary and feelings towards the spouse are left in a voice message. The time specification transmission function is used and thus the use to convey the voice message to the partner on an anniversary such as a golden wedding a anniversary.

In the system, commemorative photographs over the life span and personal private photographs can be collectively managed. Moreover, if there is a personal computer connected to the net, the photographs can be seen during journey when desired. Alternatively, photographs taken during journey are uploaded and thus it also becomes possible to let the family or friends see the photographs in real time.

Moreover, the fitting function is used to process an image of a friend without telling the friend. For example, the friend's image is caused to wear a haori and hakama for a graduation ceremony. A voice message and music are attached to the photograph, and the photograph is transmitted. Thus, the photograph can be viewed on a graduation ceremony of the friend to surprise and please him.

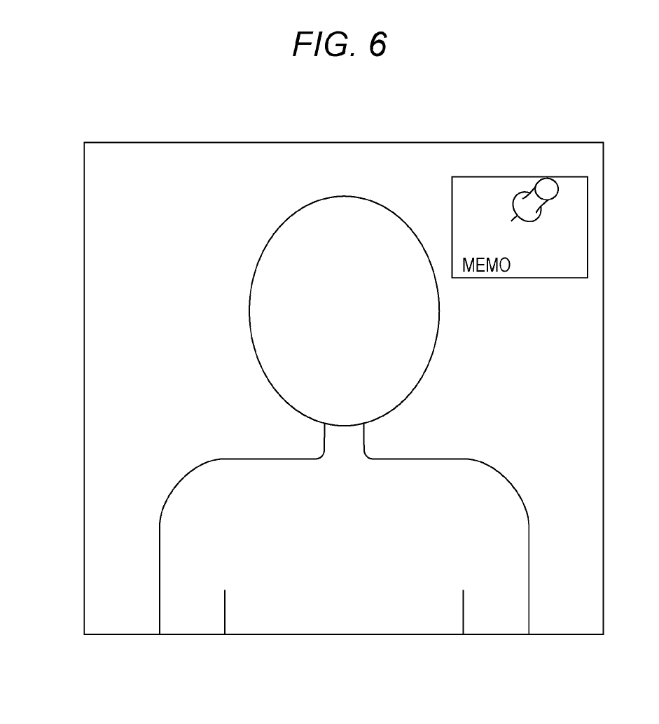

In the system, it is also effective to notify the user whether a photograph the user is viewing can be processed as in FIG. 6. For example, if a white pushpin is displayed at the top right corner of the photograph, it indicates that the photograph is editable. For example, if the color of the pushpin is red, it indicates that the photograph has been corrected. Furthermore, for example, if a memo is fastened with the pushpin, the memo is clicked to play a voice message of a person who has edited the photograph.

It is also possible to coordinate clothes and the like on the photograph of a friend. Clothes are tried on the image of the friend for coordination, or an image that has tried on new clothes of the friend's favorite label is transmitted to him/her. Thus, it is possible to let the friend know about coordination that the friend himself/herself has not recognized. To the contrary, the person in the image can also request a friend on the system for fashion coordination.

Photographs that are a basic item of the system vividly record each important scene in life as illustrated in FIG. 5. It is possible to look back on those times with nostalgia especially by seeing the photographs after a long period of time. For example, photographs taken at turning points in lives of children and friends are transmitted to them on dates and times of different turning points in lives created after a long period of time. Thus, it is possible to make a strong impression on persons to whom the photographs were transmitted and convey the warm feelings of the sender.

In this manner, photographs have a unique, special, and rare property that touches the feelings of persons across a long span of time and space in life. Therefore, the system that enables specification of a date and time and transmission to a specific person is a system that is desired by many persons. In terms of transmission on a specified date and time, it is not impossible for a user in a simple manner to use an application having the date and time specification transmission function of the user's own terminal and perform the setting individually. However, in that case, only approximately one year can be specified at the longest for specification of a date and time. This is because in these days of the short lifecycle of a computer device and software, it is hard to think about a situation where a user continues using the terminal and application for a long term. Moreover, it is also not easy at all to keep photographs and data, which have been specified regarding transmission, for a long term. If the system is managed as business, it is not difficult to maintain the system over a long period of time. However, realistically, it is very hard for individuals to maintain the system for a long term.

On the other hand, in terms of automatic transmission of photographs, there are various purposes for transmitting to the future that is separated across a very long period of time of the life of a person as has been described up to this point. If such a system that enables automatic transmission to the distant future can be easily used, the demand of the system is expected to be large. Furthermore, if the system enables specification of not only transmission to the near future such as several days from now but also transmission to the distant future such as 10 years later or 20 years later, it is also expected that the user will continue using the system over a long time. In other words, from the standpoint of a photography-related business operator, that a customer being the user of the system continues using the system for a long time generates a large commercial advantage that can maintain, a lifelong relationship with the customer.

Moreover, the automatic transmission function notifies a person at a transmission destination of a fact that photographs and audio data have become view able in the system by transmitting an email to the person at the transmission destination. On the other hand, that the system is used to view photographs and the like (or such as to listen to a voice message) increases the number of users of the system, which leads to the development of a new customer base. In order to view photographs and the like using the system, it is sufficient if the URL of the system, login ID, and password are described or the like in the body part of an email.

Moreover, if the person at the transmission destination has already become the user of the system, the latest email address of the person at the transmission destination can be found from the customer information. Hence, it is possible to notify the person with a higher possibility even after a long period of time.

Moreover, photographs and the like that have become viewable by the date and time specification transmission function are viewed by downloading the system. Hence, the advantage of the development of a new customer base, which increases the number of new users of the system, is generated for photography-related business operators.

Furthermore, specification of an access right to the data such as a photograph may be set such that the access right belongs to not only a person himself/herself, but is expanded up to his/her family and relatives, or friends and classmates. Thus, various photographs managed by the friends and the like, and the like are combined and transmitted on a specified date and time and thus, it is possible to make a stronger impression on or please them. This is also one of the main features of the system.

The following is the flow of a business model of a commemorative photograph and the like, which is performed by a conventional photography-related business operator. In other words, a customer goes to a store and changes clothes to bring-in clothing or rental clothing of the store, which matches a particular event, and have a professional cameraman take photographs. The store then creates a memory album with the images and sells it to the customer. The flow is a system that has not changed for a long time. However, photographs cannot be taken unless the customer comes to the store, and further it is also annoying to change clothes. Especially, a child's changing of clothes is hard. The younger the child is, the greater the effort is, and the child has to endure long-time photo shooting. In addition, the photo shooting cost is high and thus the customer takes photographs once or twice, but gradually comes less frequently. Alternatively, the number of customers who do not desire from the beginning to take photographs in the store is increasing.

Hence, a commemorative photograph is taken using the fitting function of the system. Thus, a photograph can be created at lower cost in terms of cost than the actual taking of a commemorative photograph and, at the same time, time and trouble to visit the studio are saved and the photograph can be created in a short time also in terms of time. Moreover, there is also a problem that once the child grows up, he/she finds photo shooting annoying. The use of the system also solves these problems. The use of the system dramatically broadens the range of choices of the customer. The choices include the following: for example, a photography related business operator can create an album by using fitting images of an event, which have been created from the images of the customer. Alternatively, the customer tries fitting on images and requests the photography-related business operator to create an album. Alternatively, the customer tries fitting on images and can also create an album by himself/herself. Furthermore, it is possible to commission the photography-related business operator from photo shooting to the creation of an album as before. With the broadening of the range of choices, the age bracket that takes commemorative photographs is broaden, and a new demand can be found. At the same time, a relationship with the photography-related business operator, which conventionally lasts only while the customer is young, is prolonged, and the effect to attract the customer is produced.

Furthermore, not only one photograph but a collection being an album is taken into the system's keeping. A message to the effect that the album has become viewable is notified by the date and time specification transmission function to a person concerned. Thus, a stronger impression can be made on the person. In this manner, the album function enables the customer to create an original album by himself/herself. Thus, a stronger motivation to continue using the system is created.

As described above, various ideas to encourage the user to continue using the system over his-her life and further over generations are contrived for the system. Thus, the system satisfies a demand of the user and at the same time does not make a relationship with the customer temporary for the photography-related business operator. This will produce very many business effects, for example, market expansion effects such as the extension of a trade, the attraction of customers, the broadening of a customer base up to relatives and friends, and the encouragement to take a commemorative photograph at advanced ages.

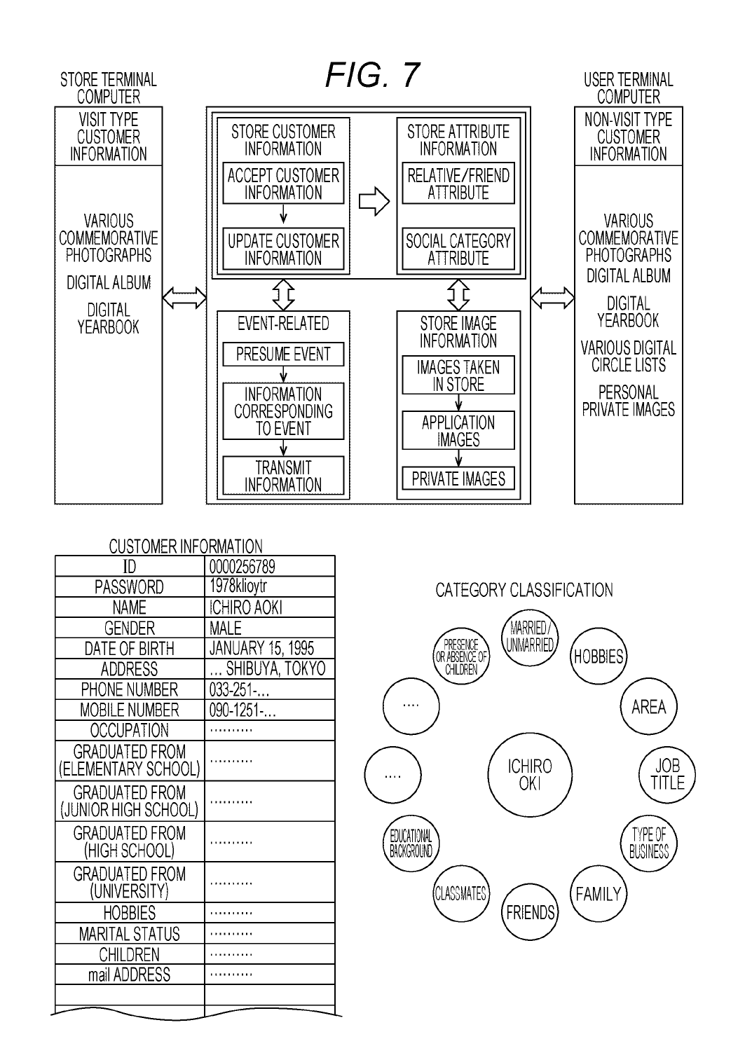

FIG. 7 is a diagram illustrating the customer information and its use.

As described above, the user continues using the system for a long time and therefore much information on the user is accumulated. The customer information is also updated and therefore the latest customer information can be held. For example, information on the relationships between the user and his/her relatives and friends, and a social category such as an area and occupation to which the user belongs is also accumulated. A timely advertisement can also be transmitted by using the information. For example, if the age of a child of the user is known, it is possible to run advertisements that encourage photo shooting in synchronization with the times of the child's events.

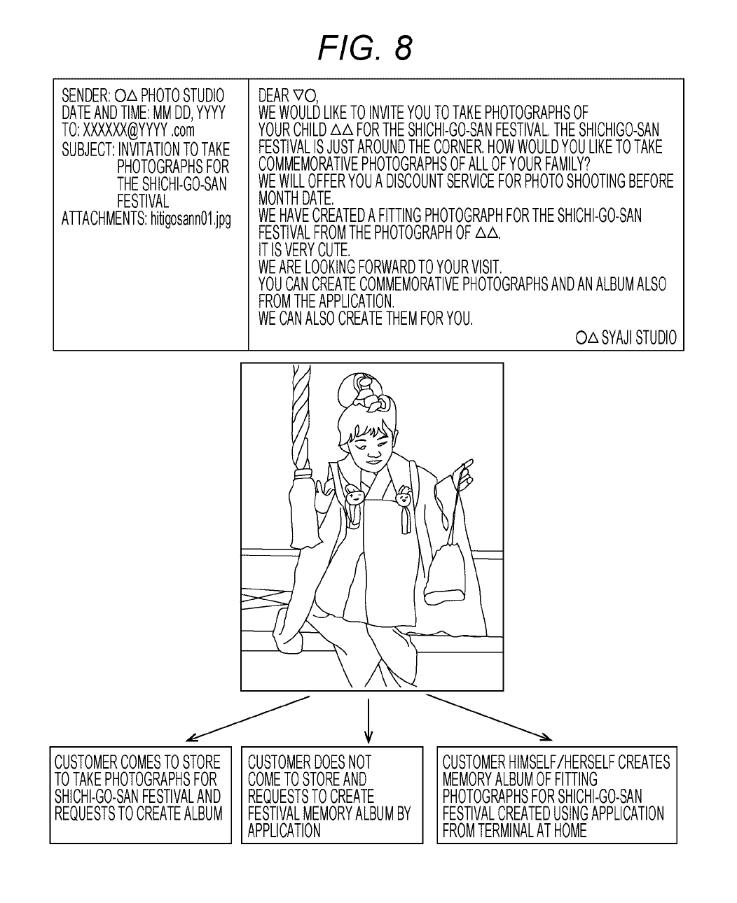

FIG. 8 illustrates this example.

When a child reaches the age of the “Shichi-Go-San Festival”, an email to encourage the taking of a commemorative photograph in a studio is transmitted to his/her parents. The email contains not only text but also a photograph of the child in Japanese kimono with arranged hair, which has been created by processing a photograph of the child. Thus, it is possible to arouse the parents' feeling that they wish to leave a real commemorative photograph. Thus, the possibility of receiving a request to take a commemorative photograph in a studio is increased. Even if a commemorative photograph cannot be taken in the studio, the user himself herself takes photographs and commissions the creation of an album with the photographs.

Alternatively, the parents themselves use the fitting function of the system, and further use the album function for the fitting images to create an electronic album. Thus, the usage charge of the application can be obtained.

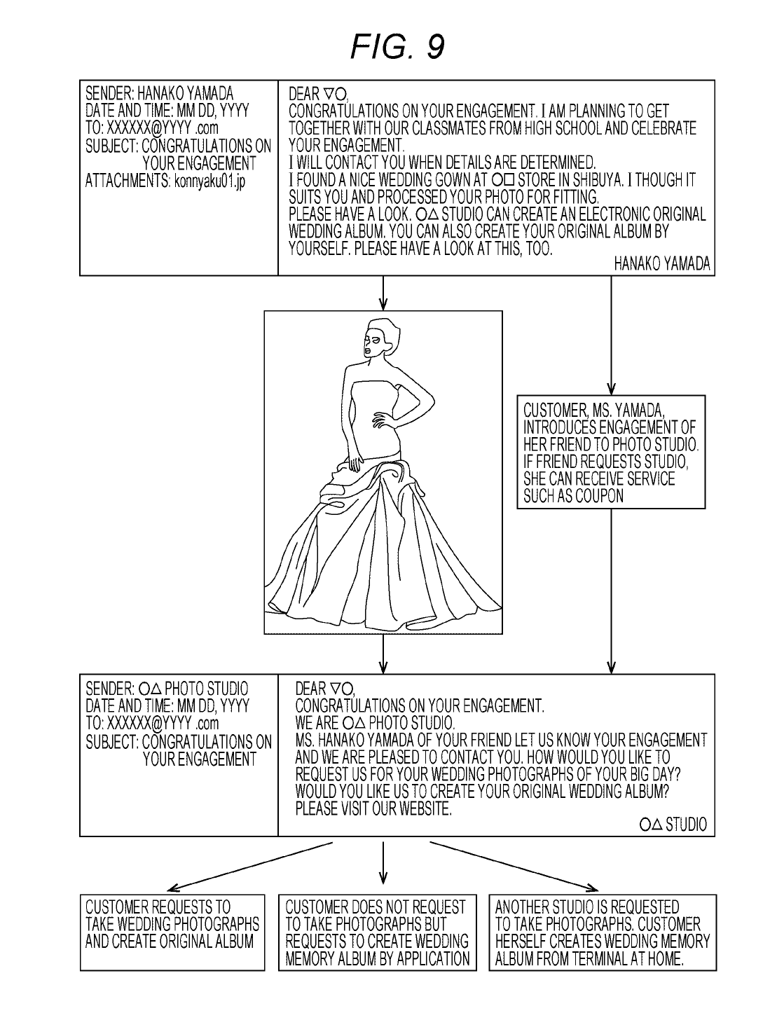

FIG. 9 is another example.

A user processes a photograph of a friend, who has just been engaged, using the fitting function of the system and thus creates a photograph of the friend in a wedding gown. The photograph is then attached to a congratulations email and transmitted to the friend. Moreover, the user introduces the user's friend, who has just been engaged, to the server manager of the system. It is arranged that the user can obtain such an advantage as to be possible to obtain a half-price coupon of studio photo shooting by the introduction of the friend. The photography-related business operator being the server manager can run an advertisement for the creation of a wedding album to the friend.

In this manner, the customer information can be expanded, and it becomes possible to run a timely advertisement from the information.

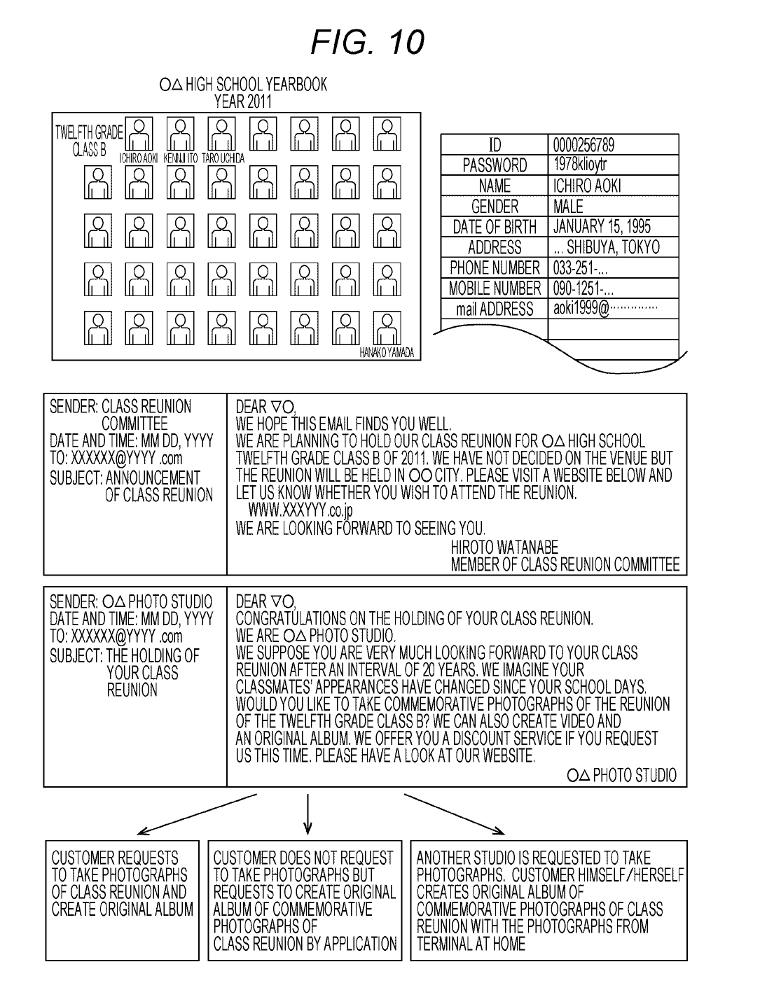

FIG. 10 illustrates a case of using the system to create a yearbook of a high school.

At least four million or more persons graduate from kindergarten, elementary school, junior high school, high school, university, vocational school, and the like every year even only in Japan. What is always taken at the time of graduation is a yearbook. The time specification transmission function, the function of attaching voice, music, and a text file such as a composition, the database function, and the time capsule function, which are included in the system, make the system to be distinguished from systems of other companies. The data of graduates of every year is accumulated, which leads to the attraction of customers for a future commemorative photograph and the like.

Computerization of school yearbook allows a user to manage a login with a user ID and password and input personal information of all the students. The students are classified, for example, by area, gender, and age based on the input information. Thus, an effective advertisement can be transmitted to each individual student.

Moreover, the computerization allows individual students to log in and easily update their personal information such as address and phone number. Thus, the system can also be used as means for obtaining the latest information. Hence, the number of company advertisements to the system is increased and the advertising revenue is also expected to be increased. With the use of the system, it can also be used to make contacts for and manage a class reunion and the like, and promote sales of commemorative photographs and the like.

As described above, the customers continue using the system for a long time, and thus information of the customers is accumulated. Events to be turning points in life, which will come to the customers in the near future, can be presumed based on the information. It becomes possible to run appropriate advertisements expected to be desired by the customers.

Specifically, it is possible to transmit, for example, advertisements in accordance with the age, for example, the customer user's gender, age, student, occupation, marriageable age, and purchase of his/her own house. Hence, advertisements of various companies can be posted, and the advertising fees can be expected.

Furthermore, for example, at the time of the “Shichi-Go-San. Festival”, an image of a child of the customer is used and images of the child trying on several items of clothing for the “Shichi-Go-San Festival” are transmitted to the customer. Thus, the customer is encouraged to take photographs. Alternatively, photographs are not taken, but a selection of favorite images is left to the customer and the photography-related business operator uses the application to create an image album of photographs of the “Shichi-Go-San Festival”. Alternatively, the customer himself/herself performs image processing to create an album. In this manner, drawing the attention of the customer and arousing the customer's feeling that he/she wishes to create commemorative photographs at any price leads to sales promotion.

Moreover; the time specification transmission function, the function of attaching voice, music, and a text file such as a composition, the database function, and the time capsule function, which are included in the system, have an effect to increase the number of requests to create a yearbook and a time capsule.

For example, a message can be recorded and attached to a photograph of each individual of a yearbook, and a personal work such as a composition can also be attached. For example, it is possible to create a digital album to which messages of teachers including a principal, or a school song is attached. If it is set such that the messages of the teachers including the principal cannot be listened to soon, but can be listened to by the students, for example, several years later, the yearbook becomes rather special.

The database function is used and thus it enables a person in charge of an alumni reunion or class reunion to notify the alumni reunion or class reunion and manage attendance with the system. The system can also be used for the management of lists of club activities, circles, a list of students' names, and various meetings.

Moreover, information on many students can be obtained from the system, thereby obtaining the following many effects, for example, companies such as a restaurant, a hotel, or a travel agency post advertisements. The companies can post advertisements that match various meetings such as a class reunion and an alumni reunion. Alternatively, companies can permanently post advertisements and the like in accordance with the age and the like of a graduate.

### INDUSTRIAL APPLICABILITY

As described above, the present invention can be applied to a system that uses a network and that stimulates communication with acquaintances centering photographs.

### DESCRIPTION OF REFERENCE SIGNS

1301 Terminal
1302 Virtual store
1303 Server
1304 Communication network
1305 Server manager terminal
1310 Server storage means
1311 Data such as a photograph
1312 Access right information
1313 Customer information
1314 Fitting data of clothes or the like
1320 Customer-authentication management means
1321 Customer authentication means
1322 Authentication-information management means
1330 Access-right setting means
1340 Customer-information setting means
1350 Date-and-time specification transmission means
1351 Specified date-and-time setting means
1352 Transmission means
1360 Fitting means
1361 Customer-fitting means
1362 Correction request means
1370 Album creation means
1380 Advertisement transmission means
1390 Database means
1400 Uploading means
1410 Downloading means

1. A data storage system for storing data such as a photograph, comprising:
storage means for allowing computers belonging to a plurality of customers to communicate with one another, and allowing a manager and the plurality of customers to upload data such as a photograph;
customer-authentication management means for authenticating the customer who logs in to the system and managing authentication information;
access-right setting means for setting, on instruction of the manager, which customer is permitted to view the data such as a photograph uploaded by the manager to the storage means and which customer is permitted to edit the data such as a photograph, among the plurality of customers, and saving the settings;
customer-information management means for storing customer information that the customer is permitted to upload to the storage means;
date-and-time specification transmission means for performing a setting to transmit a fact that information on the data such as a photograph stored in the storage means and specified by the customer, an access right of the data being held by the customer, is viewable by the data storage system, to a specified person on a specified date; and
fitting means for enabling the manager to upload fitting data of clothes or the like to the storage means and enabling the customer to try the fitting data of clothes or the like on a photograph or moving image that is editable by the customer himself/herself, view the photograph or moving image on which the fitting has been performed, and upload the photograph or moving image to the storage means, wherein
the manager of the data storage system is a photography-related business operator or a person who is commissioned by the photography-related business operator, and
the access-right setting means sets, on instruction of the customer, whether the manager is permitted to view each of data such as a photograph uploaded by the customer to the storage means or which customer among the plurality of customers is permitted to view each of the data, and whether the manager is permitted to edit each of the data or which customer among the plurality of customers is permitted to edit each of the data, and saving the settings.

2. The data storage system according to claim 1, further comprising correction request means for enabling the customer to request the manager to make a desired image correction on the photograph on which the fitting has been performed.

3. The data storage system according to claim 1, further comprising advertisement transmission means for enabling transmission of an advertisement for the manager to the customer.

4. The data storage system according to claim 3, wherein the advertisement transmission means edits a photograph of a customer, which is editable by the manager, and transmits the photograph together with the advertisement to the customer.

5. The data storage system according to claim 1, wherein upon the specified person being the customer of the data storage system, the date-and-time specification transmission means determines means for transmission to the specified person using the customer information stored in the customer-information management means.

6. The data storage system according to claim 1, wherein the date-and-time specification transmission means transmits to the specified person the fact that the information on the data specified by the customer is viewable by the data storage system, and information to log in to the data storage system.

7. The data storage system according to claim 1, further comprising database means usable by the customer.

8. The data storage system according to claim 1, further comprising album creation means for enabling creation of an album using a plurality of photographs viewable or correctable by the customer.

9. The data storage system according to claim 3, wherein
the manager or a manufacturer of the clothes and the like edits a photograph of a customer, the photograph being editable by the manager, and
the advertisement transmission means transmits to the customer the photograph together with an advertisement of the manufacturer of the clothes and the like.

10. The data storage system according to claim 1, wherein the fitting means cooperates with a website of a manufacturer of clothes and the like to allow the customer to access images of clothes and the like provided by the manufacture of clothes and the like and enable placing of an order for clothes and the like selected by the customer to the manufacturer of clothes and the like.
